(19) United States
(12) Patent Application Publication
(10) Pub. No.: US 2016/0260087 A1
(43) Pub. Date: Sep. 8, 2016

(54) SYSTEM AND METHOD OF REALIZING DUAL LOGIC CHANNELS OF SECURE ELEMENT

(71) Applicant: GOTRUST TECHNOLOGY INC., Taichung City (TW)

(72) Inventors: Tien-Chi LEE, Taichung City (TW); Jeng Lung LI, Taichung City (TW); Yi-Hsiung HUANG, Taichung City (TW)

(21) Appl. No.: 15/137,639

(22) Filed: Apr. 25, 2016

(30) Foreign Application Priority Data
Mar. 5, 2015 (TW) 104106983

(51) Int. Cl. G06Q 20/34; H04L 29/08; G06Q 20/32

(52) U.S. Cl. CPC G06Q 20/34; G06Q 20/3278; H04L 67/02

(57) ABSTRACT

A system of realizing dual logic channels of secure element includes a terminal; a mobile device; a local application module mounted in the mobile device for setting the mobile device as non-contactless or contactless communication; a secure element module mounted in the mobile device and having a smart element; and a channel mounted in the secure element module and connected with the smart element. The local application module emits a communication mode request to the smart element through the channel and then the smart element returns a signal to the terminal, completing a trading or an identification. A method based on the system includes steps of initializing the local application module and the secure element module; establishing a channel session between the local application module and the secure element module and transmitting the communication mode request to the secure element module; and transmitting information about the trading or identification.

### BACKGROUND OF THE INVENTION

1. Field of the Invention

The present invention relates generally to electronic communication and more particularly, to a system of realizing dual logic channels of secure element and a method of the same.

2. Description of the Related Art

In the current modern world with technology being developed at high speed, smart card applications have been gradually merged into the daily life of the people, such as opening doors, shopping, recreation, conference, parking, toll collection and payment, etc. Among these smart card applications, mobile payment is the most popular and has become the know-how that numerous manufacturers devote themselves to develop because of its trading convenience and swiftness.

The mobile payment includes remote payment and proximity payment. Based on non-contactless communication, the remote payment is on-line payment through Internet as electronic commerce, such as on-line web-based shopping with credit cards, on-line shopping through applications (Apps) of smart phones, or electronic wallet payment. Based on contactless communication, the proximity payment needs the sellers and buyers to face each other in person to make the trading done, such as near filed communication (NFC), quick response code (QR Code), or mobile credit cards that have become popular recently.

Referring to FIG. 1, a conventional smart card 90 can do both the remote payment and the proximity payment and provide two independent communication interfaces formed of a non-contactless communication interface 92 and a contactless communication interface 94. When it is intended to proceed with the remote payment, the smart card 90 and a local App 96 can transfer data therebetween through the non-contactless communication interface 92 based on ISO-7816 protocol and meanwhile, the smart card 90 can be connected to the internet through the local App 96 for trading with a remote server 98. While it is intended to proceed with the proximity payment, the smart card 90 needs to approach a reader 99 for connection based on single wire protocol (S WP) with the reader 99 and then the trading can proceed further.

To facilitate the mobile payment of the mobile device, Google Inc. provides its developed operating system, Android (version 4.4) with host card emulation (HCE). The HCE can read a smart card packaged in a secure digital (SD) memory card or a subscriber identity module (SIM) card and a user can use either mobile device, such as mobile phone or tablet computer, for mobile payment.

However, the pattern that the smart card is packaged inside the SD card or SIM card has gradually become more and more diverse to increase the application contexts of the smart card, so the conventional smart card having dual channels (non-contactless and contactless) may not realize intended access control, e.g. the HCE can access the smart card only through ISO-7816 and in consideration of cost and performance, most of service providers, such as banks, tend to redevelop new application judging logics for such new application contexts of the smart card.

When the smart card is used for identification or identity recognition, the same problem will happen. For example, some web-based banks need the smart card for user login, or doors having access restrictions need identification for unlocking locks thereof. The technology though makes progress, but the prior art is different to some degree from state of the art and the diverse application contexts may make the conventional dual-channel smart cards fail to access intended targets, thus leading to users' inconvenience.

In view of the above, how to develop a package design of a smart card having one external channel and two internal channels to make the smart card widely compatible and make data transmission between the smart card and either mobile device confidential and secure is what is needed for the market but had not been presented.

### SUMMARY OF THE INVENTION

The primary objective of the present invention is to provide a system of realizing dual logic channels of secure element and a method of the same, which can send a non-contactless communication command or a contactless communication command from a local App of a local application module and then transmit the command through at least one of the channels to make the secure element switched to a non-contactless communication mode or a contactless communication mode to further enable the secure element for dual-channel (non-contactless and contactless) trading or identification in a new application context of smart card.

The foregoing objective of the present invention is attained by the system formed of a mobile device, at least one channel, and a communication mode request. The mobile device includes a local application module and a secure element module. The local application module includes a local App and a local application channel controller. Data transmission can be done between the local App and a terminal. The secure element module includes a secure element channel controller and a smart element. The smart element further includes an applet for controlling or switching the smart element for the non-contactless communication mode or a contactless communication mode. Data transmission can also proceed between the secure element channel controller and the local application channel controller. The at least one channel is located between the secure element channel controller and the smart element. The communication mode request can be a non-contactless communication command or a contactless communication command. The communication mode request is emitted from the local App, passes through the local application channel controller and the secure element channel controller, and is then transmitted to the applet.

Preferably, the at least one channel is two or more in number. If there are two said channels, the two channels will be a non-contactless channel and a contactless channel, respectively. When the secure element channel controller transmits the non-contactless communication command, the command is transmitted to the smart element through the non-contactless channel.

Preferably, the at least one channel is one in number. When the secure element channel controller transmits the non-contactless communication command or the contactless communication command, the command is transmitted through the channel.

Preferably, the system further includes a secure channel located between the local application channel controller and the secure element channel controller for assuring that the local application channel controller and the secure element channel controller are one-on-one and for protecting confidentiality of contactless data transmission.

Preferably, the terminal is a trading terminal and transmission of trading data can proceed between the trading terminal and the local App.

Preferably, the terminal is an identification terminal and transmission of identification data can proceed between the identification terminal and the local App.

The foregoing objective of the present invention is also attained by the method having the following steps.
1. Initialize the local application module and the secure element module.
2. Establish a channel session between the local application channel controller and the secure element channel controller and transmit the communication mode request to the secure element channel controller.
3. Transmit information about trading or identification.

In the step 2, the local App transmits the communication mode request to the local application channel controller, the channel session is established between the local application channel controller and the secure element channel controller, and the local application channel controller transmits the communication mode request to the secure element channel controller. The communication mode request can be the non-contactless communication command or the contactless communication command After the secure element channel controller receives the communication mode request, the smart element can be set to the non-contactless communication mode or the contactless communication mode according to the communication mode request which is the non-contactless communication command or the contactless communication command.

In the step 3, the terminal transmits a request signal to the local App, the local App further transmits the request signal to the local application channel controller, and then the local application channel controller transmits the request signal to the secure element channel controller. After receiving the request signal, the secure element channel controller transmits it to the applet. After receiving the request signal, the applet emits a responsive signal matching non-contactless or contactless trading or identification. After receiving the responsive signal, the secure element channel controller transmits it to the local application channel controller. After that, the local application channel controller further transmits the responsive signal to the local App and then the local App transmits it to the terminal.

Preferably, the secure element channel controller transmits the non-contactless communication command and the contactless communication command through a non-contactless channel and a contactless channel, respectively.

Preferably, the secure element channel controller transmits the non-contactless communication command or the contactless communication command through a channel.

Preferably, data transmission between the local application channel controller and the secure element channel controller proceeds through a secure channel. A one-time channel session key is generated based on a secure channel master key and serves as a security mechanism for preventing information from tamper.

Preferably, the method further includes a step 4. In the step 4, the local application channel controller further emits a disconnection request to the secure element channel controller to make the secure element channel controller disconnected from the local application channel controller, thus completing a trading or identification.

In short, the system of the present invention integrates the non-contactless communication module with the contactless communication module to make them become one communication module and the local App controls and sets the communication module to the non-contactless communication mode or the contactless communication mode to enable the communication module to proceed with a non-contactless or a contactless trading or an identification via a non-contactless or contactless trading or identification terminal, so the design purpose of two internal channels and one external channel for the present invention can be reached to make the smart element widely compatible. In addition, the secure channel session key is used for protecting the confidentiality of the data transmission between the smart element and either mobile device to prevent malicious people from stealing confidential data to further enhance the safety of mobile payment.

### BRIEF DESCRIPTION OF THE DRAWINGS

FIG. 1 is a schematic view of communication of a conventional smart card.

FIG. 2 is a block diagram of the system of a first preferred embodiment of the present invention, illustrating that a communication mode request is emitted.

FIG. 3 is similar to FIG. 2, illustrating that a request signal and a responsive signal are emitted.

FIG. 4 is a block diagram of the system of a second preferred embodiment of the present invention, illustrating that a communication mode request is emitted.

FIG. 5 is a block diagram of the system of a third preferred embodiment of the present invention.

FIG. 6 a block diagram of the system of a fourth preferred embodiment of the present invention.

FIG. 7 is a schematic view of the system of the present invention in practice.

FIG. 8 a schematic view of communication of the present invention.

FIG. 9 is a flow chart of the method of the present invention.

FIG. 10 is a flow chart of the first step of the method of the present invention in detail.

FIG. 11 is a flow chart of the second step of the method of the present invention in detail.

FIG. 12 is a flow chart of the third step of the method of the present invention in detail.

FIG. 13 is a flow chart of the fourth step of the method of the present invention.

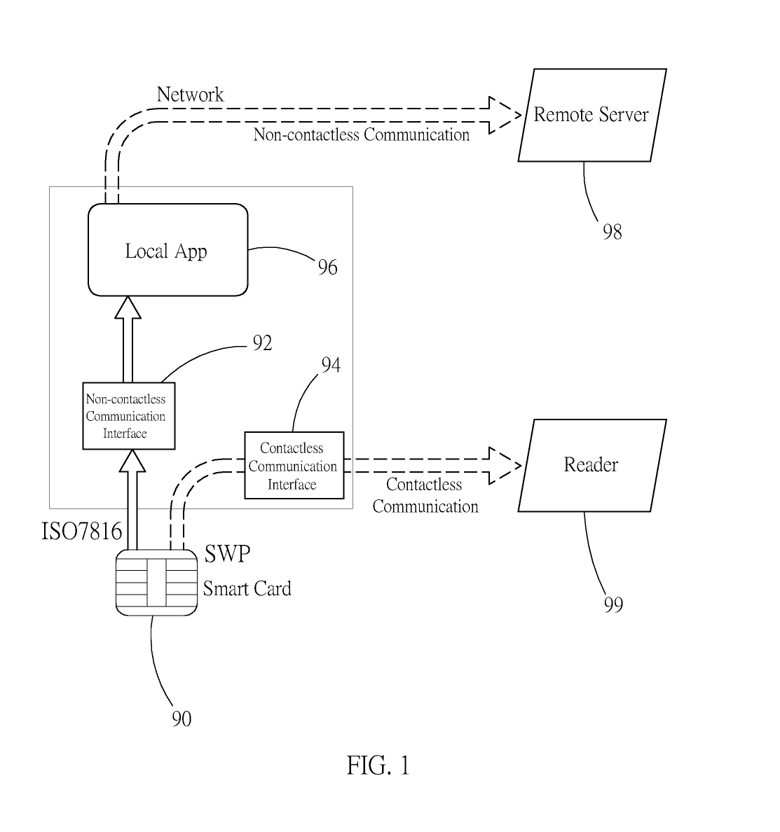

### DETAILED DESCRIPTION OF PREFERRED EMBODIMENTS

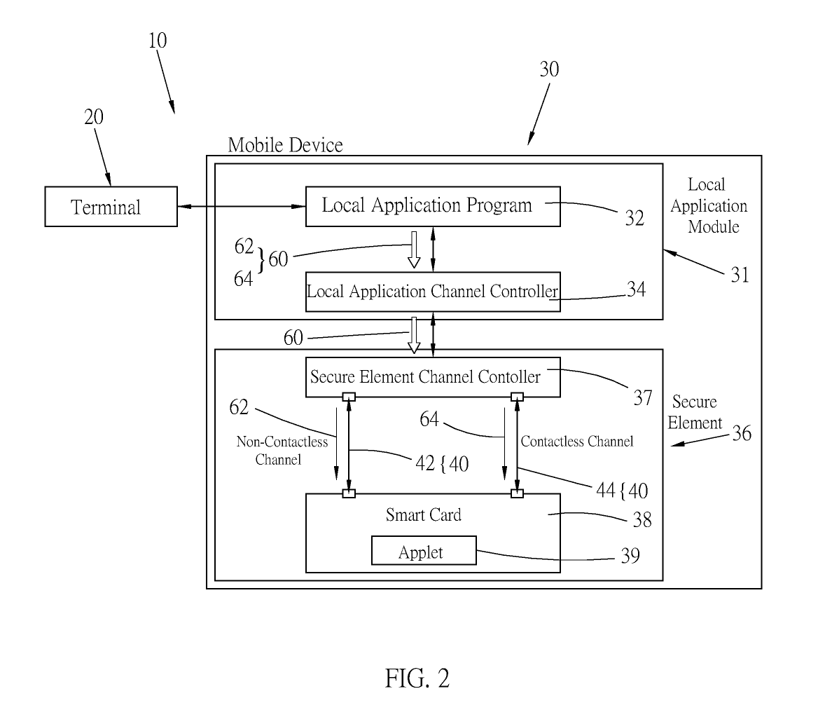

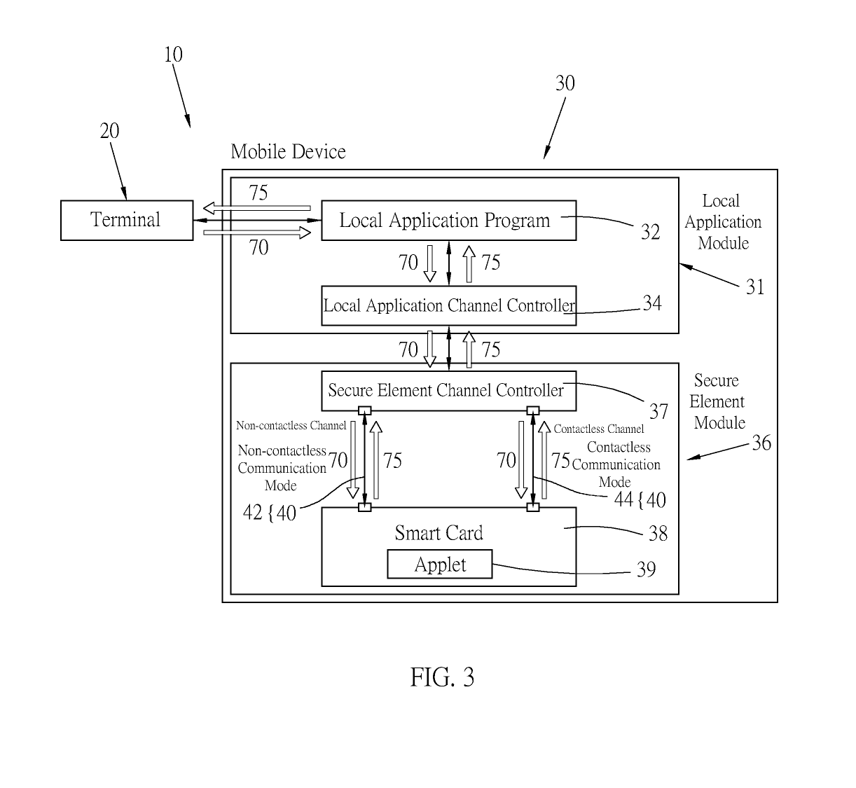

Referring to FIGS. 2 and 3, a system 10 of realizing dual logic channels of secure element in accordance with a first preferred embodiment of the present invention is formed of a terminal 20, a mobile device 30, and two channels 40.

The terminal 20 can be a remote server of non-contactless communication or a reader of contactless communication. The terminal 20 can be a trading terminal or an identification terminal if it is intended to proceed with a shopping trading or an identity authentication. The terminal 20 can emit a request signal 70. In this embodiment, the contactless communication is based on near field communication (NFC) for data transmission.

The mobile device 30 can be either of portable devices like smart phones and tablet computers and can do non-contactless or contactless communication with the terminal 20. If the communication taking place between the mobile device 30 and the terminal 20 is contactless, the terminal 20 will be a remote server. If the communication taking place between the mobile device 30 and the terminal 20 is non-contactless, the terminal 20 will be an NFC reader. The mobile device 30 further includes a local application module 31 and a secure element module 36. Data transmission can proceed between the local application module 31 and the secure element module 36. The local application module 31 can control and make the mobile device 30 do non-contactless or contactless communication. The local application module 31 further includes a local App 32 and a local application channel controller 34. Data transmission can proceed between the local App 32 and the local application channel controller 34. Non-contactless communication, e.g. Global System for Mobile (GSM) or Wireless Fidelity (Wi-Fi), or contactless communication, e.g. NFC, can proceed between the local App 32 and the terminal 20, depending on which communication type the terminal 20 is. The local App 32 can transmit a communication mode request 60 to the local application channel controller 34. The communication mode request 60 can be a non-contactless communication command 62 or a contactless communication command 64. The secure element module 36 includes a packaged secure element channel controller 37 and a packaged smart element. The smart element is, for example, a smart card 38 in this embodiment. The secure element module 36 can be connected with a local mobile device through an appropriate hardware interface and communicate with an App of the local mobile device through an appropriate software interface, e.g. secure digital input/output (SDIO). The hardware interface can be an SD card, a SIM, an embedded secure element, or an external device in wired or wireless connection with the mobile device 30. In this embodiment, the secure element module 36 is packaged in a microSD card. The smart card 38 further includes an applet 39 for setting the smart card 38 as a non-contactless communication mode or a contactless communication mode. Data transmission can proceed between the secure element channel controller 37 and the local application channel controller 34. The secure element channel controller 37 can receive the communication mode request 60 from the local application channel controller 34. Data transmission can proceed between the applet 39 and the secure element channel controller 37. The applet 39 can receive the communication mode request 60 from the secure element channel controller 37 to switch itself to the non-contactless communication mode or the contactless communication mode.

One of the two channels 40 is a non-contactless channel 42 and the other is a contactless channel 44. The two channels 40 are located between the secure element channel controller 37 and the smart card 38. The secure element channel controller 37 can transmit the non-contactless communication command 62 or the contactless communication command 64 through the two channels 42 and 44. The two channels 40 are physical circuits, such as pins or contacts.

When the secure element channel controller 37 transmits the non-contactless communication command 62, the non-contactless communication command 62 is transmitted to the smart card 38 through the non-contactless channel 42. When the secure element channel controller 37 transmits the contactless communication command 64, the contactless communication command 64 is transmitted to the smart card 38 through the contactless channel 44.

Referring to FIG. 2, when the system 10 of the present invention is operated, the secure element module 36 (e.g. microSD) is mounted to the mobile device 30 (e.g. cellular phone) and data transmission takes place between the secure element module 36 and the mobile phone 30. When a user uses the mobile device 30 to work with the terminal 20 for trading or identification, the local App 32 can emit the communication mode request 60 to the local application channel controller 34 and then the local application channel controller 34 transmits the communication mode request 60 to the secure element channel controller 37; after that, the secure element channel controller 37 further transmits the communication mode request 60 to the smart card 38 through the non-contactless channel 42 or the contactless channel 44 according to the communication mode request 60 which is the non-contactless communication command 62 or the contactless communication command 64.

The applet 39 of the smart card 38 switches the smart card 38 to the non-contactless communication mode 62 or the contactless communication mode 64 according to the communication mode request 60 which is the non-contactless communication command 62 or the contactless communication command 64.

Referring to FIG. 3, the terminal 20 transmits the request signal 70 to the local App 32 and then the local App 32 transmits the request signal 70 to the local application channel controller 34; after that, the local application channel controller 34 further transmits the request signal 70 to the secure element channel controller 37, and then the secure element channel controller 37 transmits the request signal 70 to the applet 39 through the non-contactless channel 42 or the contactless channel 44 according to the smart card 38 which is of the non-contactless communication mode or the contactless communication mode.

After receiving the request signal 70, the applet 39 can emit a responsive signal 75 through the same channel, namely the non-contactless channel 42 or the contactless channel 44, to the secure element channel controller 37 and then the responsive signal 75 is transmitted to the terminal 20 through the local application channel controller 34 and the local App 32. Therefore, transmission of required information for the trading or the identification is completed.

In light of the above, the system 10 of the present invention uses the local App 32 to switch the communication mode of the smart card 38 for application to non-contactless trading (e.g. on-line trading), contactless trading (e.g. micro-payment), or identification, thus enhancing practicability of smart card applications.

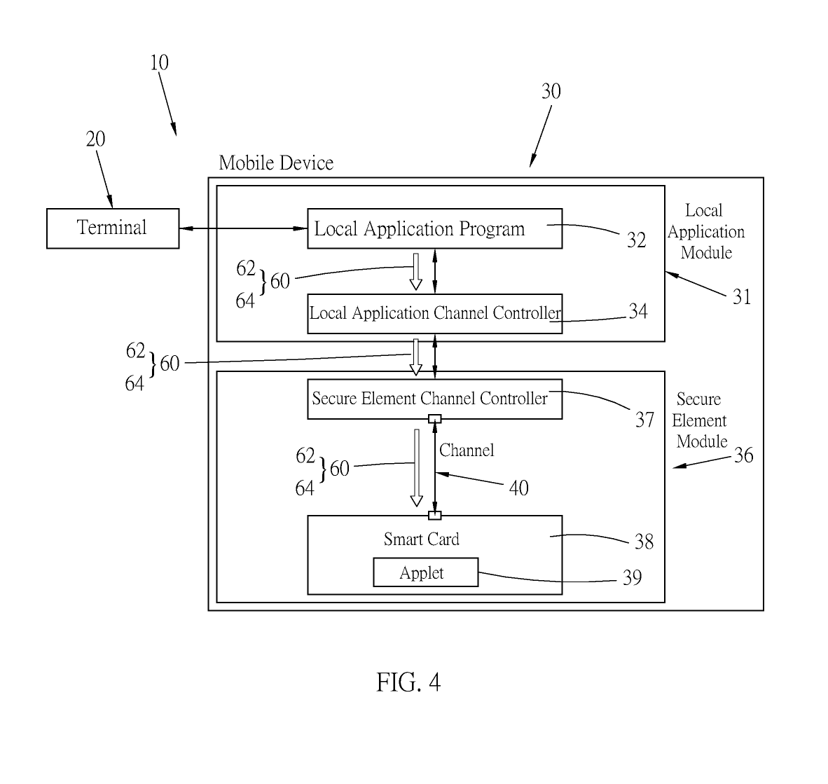

Referring to FIG. 4, the system 10 of a second preferred embodiment of the present invention is similar to that of the first preferred embodiment. The difference between the two preferred embodiments lies in that the system 10 of the second preferred embodiment includes only one said channel 40 located between the secure element controller 37 and the smart card 38. When it is intended to proceed with a trading or identification, the local application module 31 can inform the secure element module 36 of the message about the contactless or non-contactless trading or identification and then switch the secure element module 36 to the non-contactless communication mode or the contactless communication mode logically by software, The non-contactless communication command 62 or the contactless communication command 64 emitted from the secure element channel controller 37 is transmitted to the smart card 40 through the channel 40. After receiving the command 62 or 64, the applet 39 of the smart card 38 is switched to the non-contactless communication mode or the contactless communication mode. In this way, the applet 39 can correctly process the request signal 70 from the terminal 20 and then return the responsive signal 75 to the terminal 20 for the purpose of the non-contactless or contactless trading or identification.

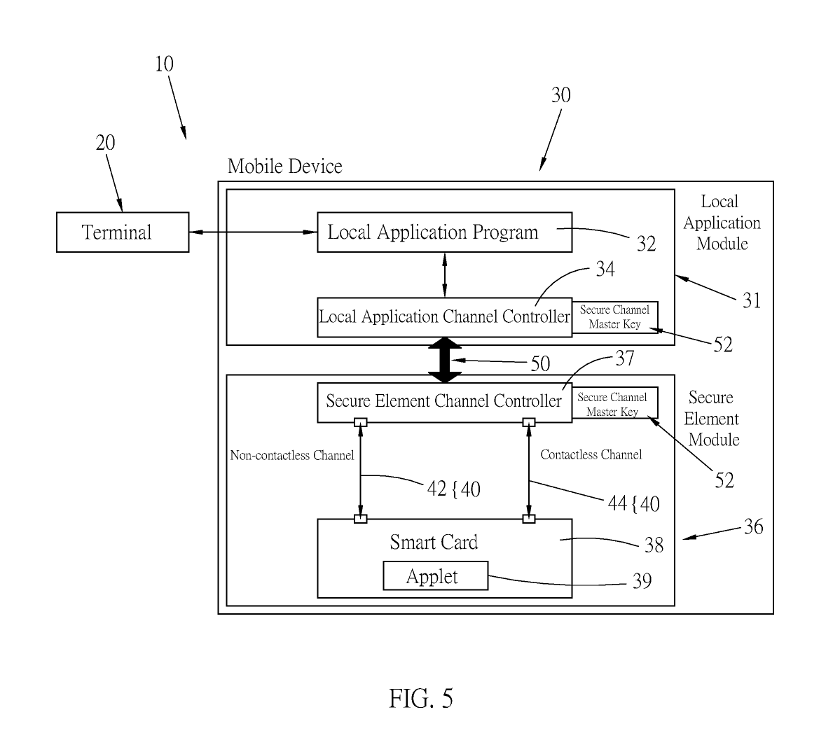

Referring to FIG. 5, the system 10 of a third preferred embodiment of the present invention is similar to that of the first preferred embodiment. The difference between the two embodiments lies in that the system 10 of the third preferred embodiment further includes a secure channel 50 located between the local application channel controller 34 and the secure element channel controller 37. The secure channel 50 can use a secure channel master key 52 to apply identification to the local application channel controller 34 and the secure element channel controller 37 and create a one-time channel session key (not shown). The one-time channel session key can prevent the communication between the two controllers 34 and 37 from tamper to ensure that the two controllers 34 and 37 are solely bundled (one-on-one) and to protect the confidentiality of the contactless communication.

In the third preferred embodiment, the identification and how to create the one-time channel session key between the two controllers 34 and 37 are based on a conventional challenge-response protocol as recited hereinafter. First, the local application channel controller 34 emits a connection request to the secure element channel controller 37, the secure element channel controller 37 generates and returns a challenge (not shown) to the local application channel controller 34, and then the challenge is encrypted by the secure channel master key 52, thus getting a secure channel session key. Second, after receiving the challenge is received, the local application channel controller 34 encrypts the challenge by means of the secure channel master key 52, thus getting a local channel session key (not shown). After that, message authentication code (MAC) of a local request signal is figured out by means of the local channel session key and then transmitted to the secure element channel controller 37 for comparison. Next, the secure element channel controller 37 figures out MAC of a secure request signal by means of the secure channel session key and then the MAC of the secure request signal is compared with the MAC of the local request signal. If the MAC conforms to the other, the request signal 70 will be transmitted to the smart card 38 and then the trading or identification will proceed further.

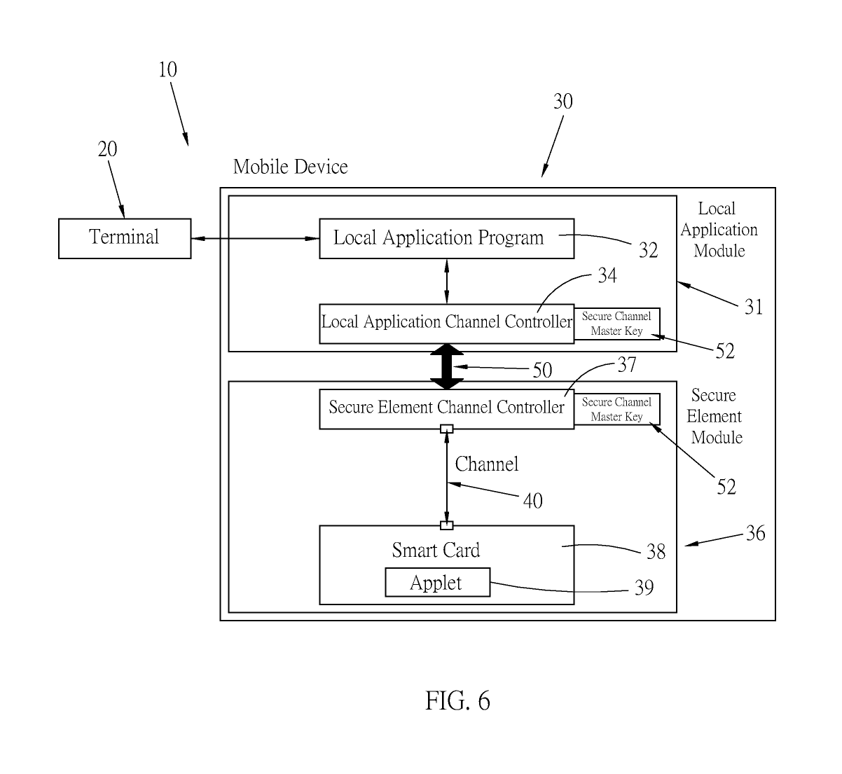

Referring to FIG. 6, the system 10 of a fourth preferred embodiment of the present invention is similar to that of the second preferred embodiment. The difference between the two embodiments lies in that the system 10 of the fourth preferred embodiment further includes the secure channel 50 located between the local application channel controller 34 and the secure element channel controller 37. The secure channel 50 can proceed with identification and create the channel session key by means of the conventional challenge-response protocol. The identification and how to create the channel session key have been described in the third preferred embodiment as mentioned above, so recitation thereof will be skipped.

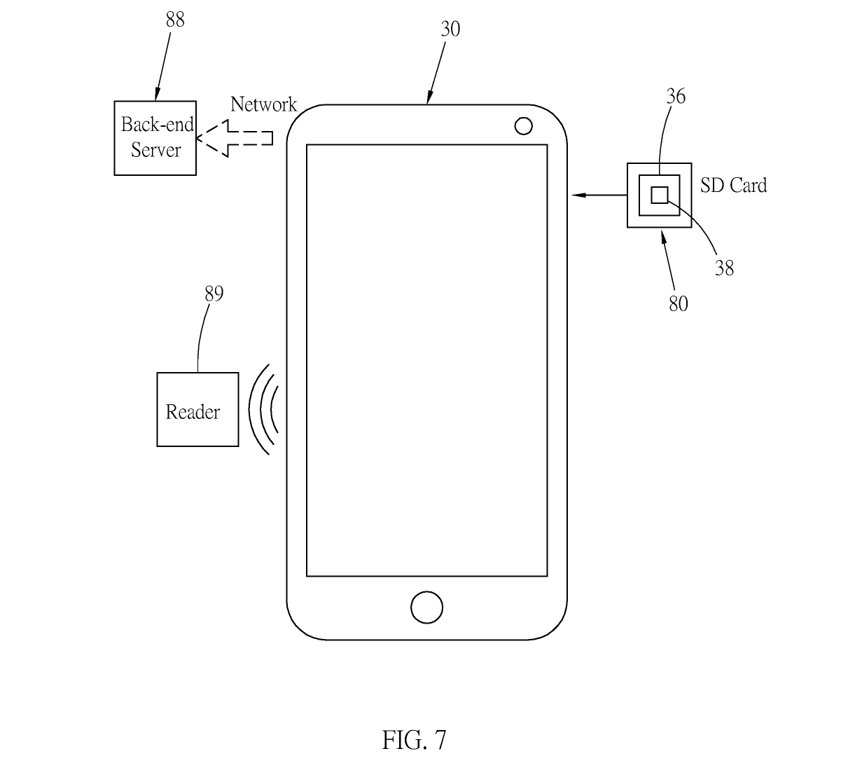

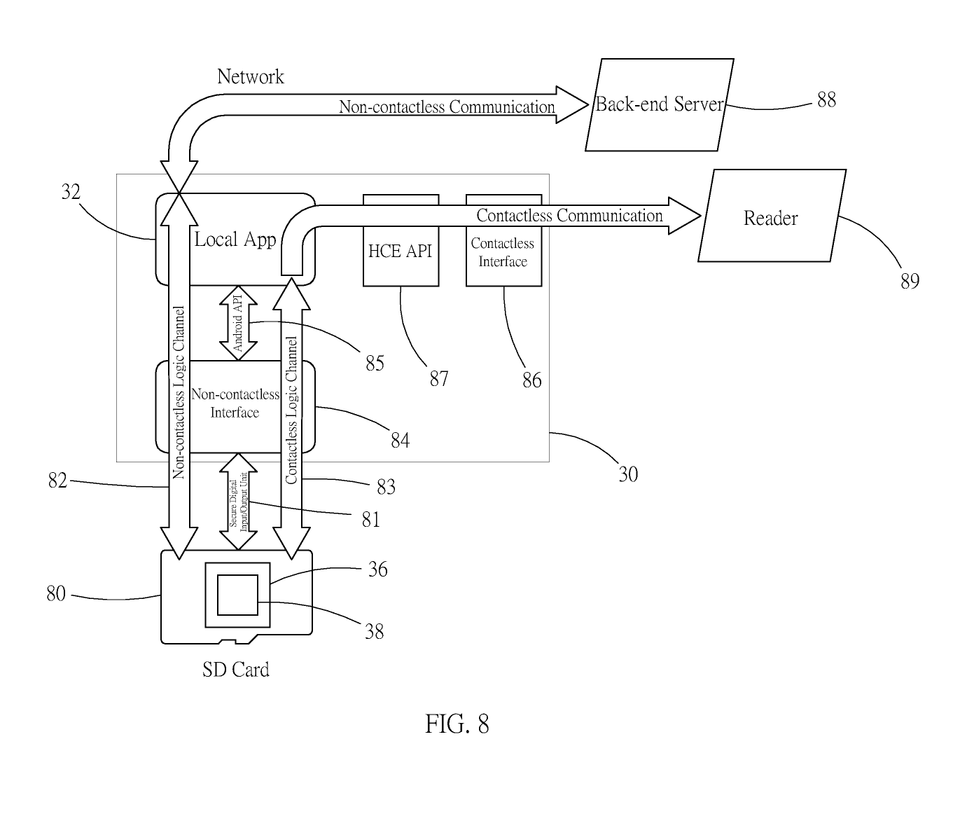

Referring to FIGS. 7-8, the system 10 of the present invention also includes the terminal 20, the mobile device 30, the local application module 31, and the secure element module 36. The secure module 36 is packaged inside an SD card 80. The mobile device 30 can be a mobile phone (not shown) or a tablet computer (not shown). The local application module 31 is packaged in the mobile device 30. The mobile device 30 further includes a non-contactless interface 84 and a contactless interface 86. The non-contactless interface 84 communicates with the local App 32 by means of an application programming interface (API). Data transmission can proceed between the local App 32 and the contactless interface 86 by means of an HCE API 87. The SD card 80 further includes a secure digital input/output unit 81 by means of which data transmission can proceed between the SD card 80 and the non-contactless interface 84 while the SD card 80 is inserted into the non-contactless interface 84 of the mobile device. Anon-contactless logic channel 82 and a contactless logic channel 83 are connected between the local App 32 and the SD card 80 for transmission of the responsive signal 75 and the non-contactless communication command 62 or the contactless communication command 64.

When the system 10 proceeds with a non-contactless trading or a non-contactless identification, the local App 32 can transmit the non-contactless communication command 62 to the SD card 80 through the non-contactless logic channel 82 to make the smart card 38 switched to the non-contactless communication mode. After the smart card 38 is switched to the non-contactless communication mode, the request signal 70 is emitted from a back-end server 88, then transmitted to the local App 32 of the mobile device 30 through Internet, and finally transmitted to the SD card 80 through the non-contactless logic channel 82. After receiving the request signal 70, the SD card 80 returns the responsive signal 75 to the back-end server 88 through the non-contactless logic channel 82. After that, the non-contactless trading or the non-contactless identification is completed.

When the system 10 proceeds with a contactless trading or a contactless identification, the local App 32 can transmit the contactless communication command 64 to the SD card 80 through the contactless logic channel 83 to make the smart card 38 switched to the contactless communication mode. After the smart card 38 is switched to the contactless communication mode, the request signal 70 is emitted from a reader 89, then transmitted to the local App 32 of the mobile device 30 via NFC, and finally transmitted to the SD card 80 through the contactless logic channel 83. After receiving the request signal 70, the SD card 80 returns the responsive signal 75 to the reader 89 through the contactless logic channel 83. After that, the contactless trading or the contactless identification is completed. If the secure channel 50 is available in the system 10, when a trading or an identification starts, the local App 32 will acquire the secure channel master key 52 and then the secure element controller 37 and the local App 32 will jointly create the channel session key by means of the secure channel master key 52. Data transmitted in connection with the trading or the identification are all encrypted by the channel session key, so the data transmitted between the SD card 80 and the back-end server 88 can be ensured for accuracy, thus preventing a third party from stealing personal information or trading data.

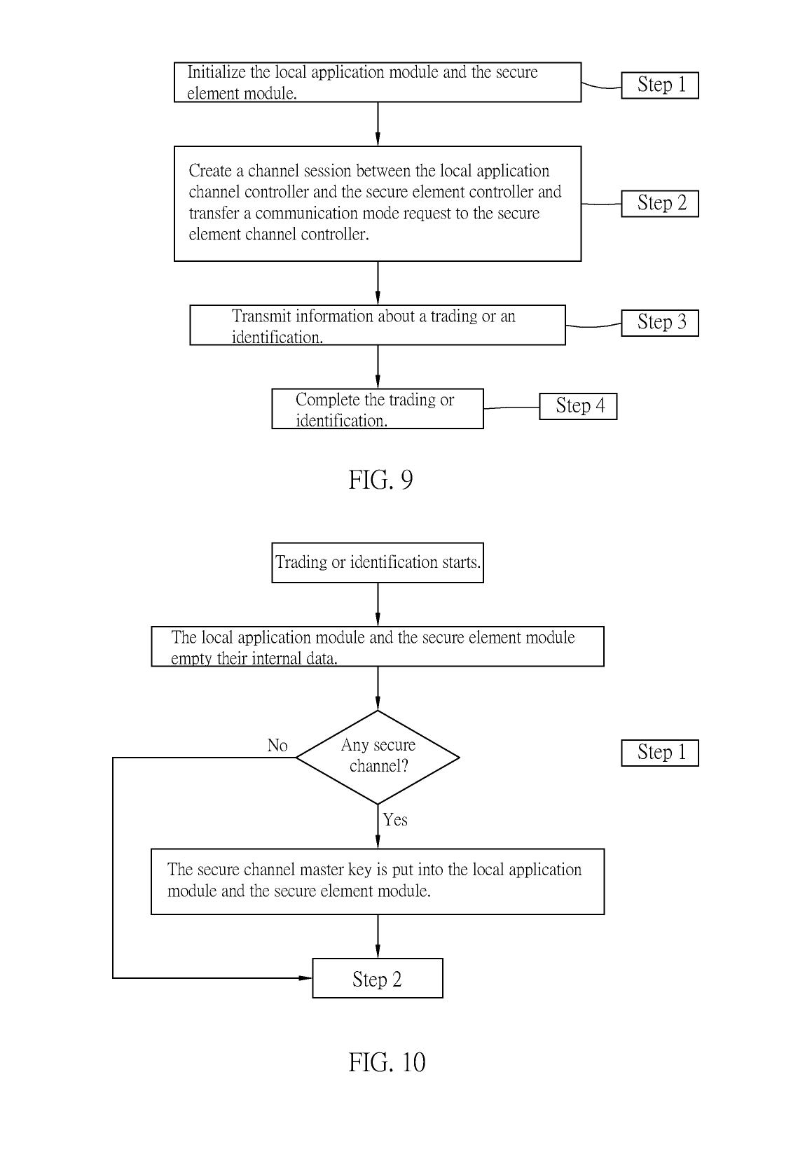

Referring to FIG. 9, a method of executing a non-contactless or contactless trading or identification according to the present invention includes the following steps.

Step 1: Initialize the local application module 31 and the secure element module 36. Details are recited hereunder.

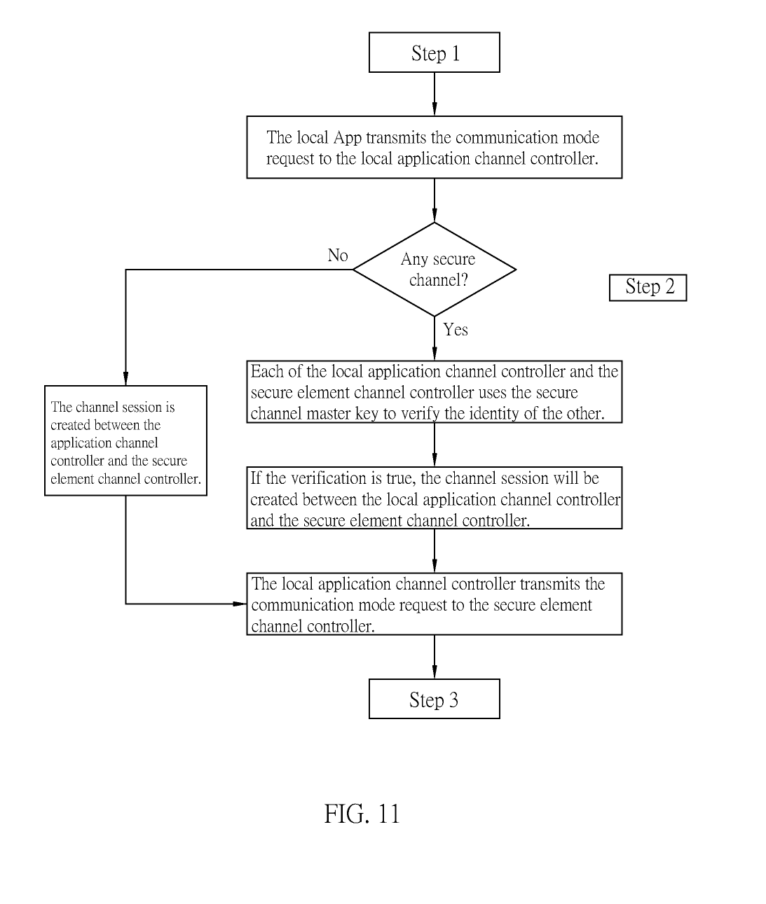

Referring to FIG. 10, the local application module 31 and the secure element module 36 empty their internal data to become default, so a new trading or identification can start to proceed further. If the secure channel 50 is available in the system 10, after the local application module 31 and the secure element module 36 empty their internal data, the secure channel master key 52 is put into the local application module 31 and the secure element module 36.

Step 2: Create a channel session between the local application channel controller 34 and the secure element controller 37 and transfer a communication mode request 60 to the secure element channel controller 37. Details are recited hereunder. Referring to FIG. 11, the local App 32 transmits the communication mode

request 60 to the local application channel controller 34 and then the channel session is created between the application channel controller 34 and the secure element channel controller 37 to enable the application channel controller 34 and the secure element channel controller 37 to transmit data therebetween and transmit the communication mode request 60 to the secure element channel controller 37. The communication mode request 60 can be the non-contactless communication command 62 or the contactless communication command 64.

After the secure element channel controller 37 receives the communication mode request 60, the smart card 38 can be set as the non-contactless communication mode or the contactless communication mode according to the communication mode request 60 which is the non-contactless communication command 62 or the contactless communication command 64.

If the system 10 is provided with the secure channel 50, each of the local application channel controller 34 and the secure element channel controller 37 can use the secure channel master key 52 to verify the identity of the other and to generate the channel session key. If the verification is true, the trading can proceed further. Otherwise, namely if the verification is false, an error processing will proceed. Since the error processing belongs to prior art and is none of any primary technical features of the present invention, its detailed recitation is skipped.

Step 3: Transmit information about a trading or an identification. Details are recited hereunder.

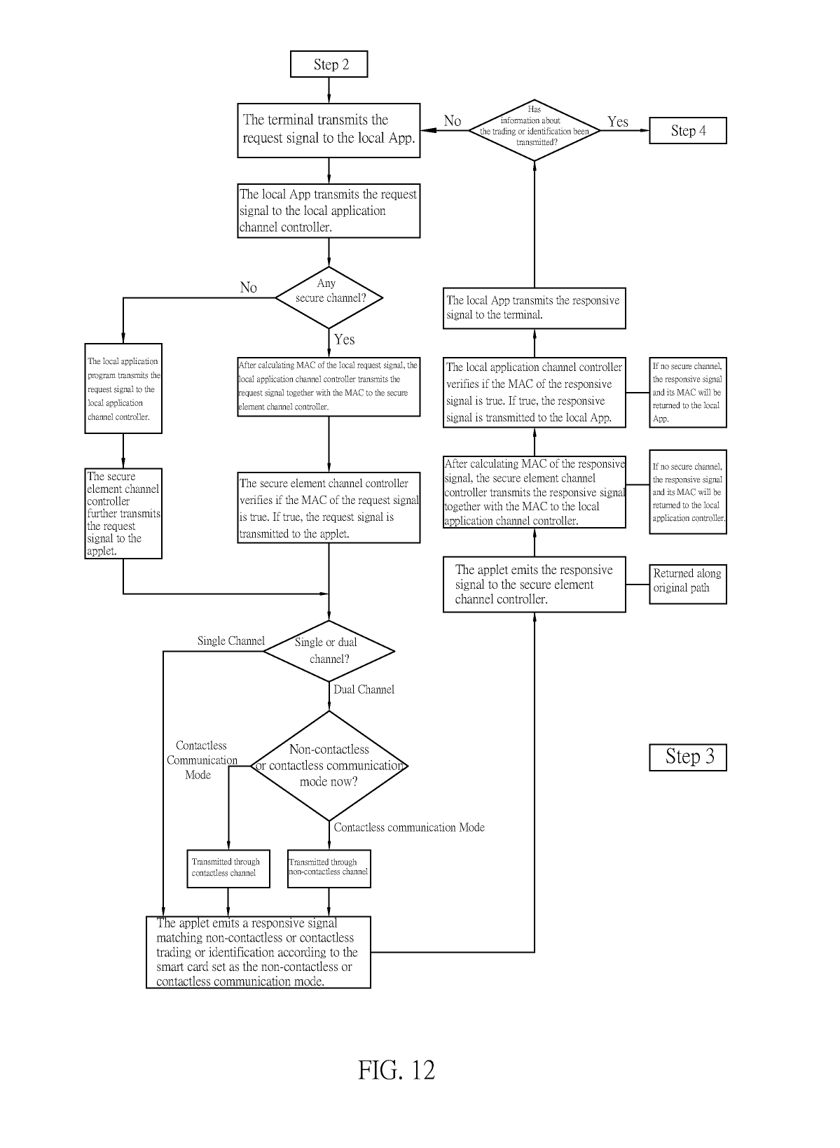

Referring to FIG. 12, the terminal 20 transmits the request signal 70 to the local App 32 of the local application module 31 of the mobile device 30; next, the local App 32 transmits the request signal 70 to the local application channel controller 34; the local application channel controller 34 further transmits the request signal 70 to the secure element channel controller 37.

After receiving the request signal 70, the secure element channel controller 37 further transmits the request signal 70 to the applet 39. Next, the applet 39 emits a responsive signal 75 matching non-contactless or contactless trading or identification according to the smart card 38 set as the non-contactless communication mode or the contactless communication mode. After receiving the responsive signal 75, the secure element channel controller 37 transmits the responsive signal 75 to the local application channel controller 34. Further, the local channel controller 34 transmits the responsive signal 75 to the local App 32 and then the local App 32 transmits the responsive signal 75 to the terminal 20.

If the system 10 is provided with the secure channel 50, after the local application channel controller 34 receives the request signal 70, the local channel session key can be used to calculate MAC of the local request signal and then the request signal 70 together with the MAC of the local request signal is transmitted to the secure element channel controller 37.

After receiving the request signal 70, the secure element channel controller 37 uses the secure channel session key to figure out the MAC of the secure request signal and then compare whether the MAC of the local request signal conforms to the MAC of the secure request signal. If they conform to each other, the request signal 70 will be true and transmitted to the applet 39 of the smart card 38 and then the applet 39 can return the responsive signal 75 according to the current communication mode. If they do not conform to each other, an error processing will proceed further. Since the error processing belongs to prior art and is none of any primary technical features of the present invention, its detailed recitation is skipped.

The secure element channel controller 37 uses the secure channel session key 81 to calculate MAC of a secure responsive signal and then the MAC of the responsive signal 75 and the MAC of the secure responsive signal are returned to the local application channel controller 34.

The local application channel controller 34 also uses the local channel session key to calculate MAC of a local responsive signal and compares the MAC of the local responsive signal with the MAC of the secure responsive signal. If they conform to each other, the responsive signal 75 will be true and transmitted to the terminal 20 through the local App 32, thus completing signal transmission required for the trading or identification. If they do not conform to each other, an error processing will proceed further. Since the error processing belongs to prior art and is none of any primary technical features of the present invention, its detailed recitation is skipped.

At the end of the step 3, the trading is completed or the identification is authenticated and then another trading or identification can proceed further.

The method of executing a non-contactless or contactless trading or identification according to the present invention can further include a step 4 of closing connection. Details are recited hereunder.

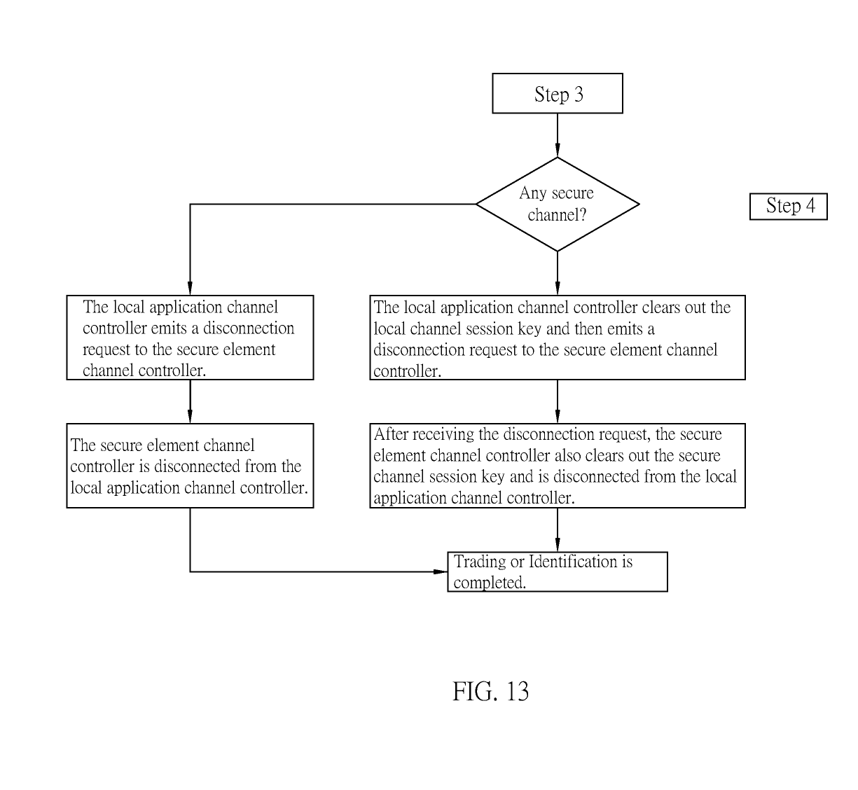

Referring to FIG. 13, the local application channel controller 34 emits a disconnection request to the secure element channel controller 37. After receiving the disconnection request, the secure element channel controller 37 is disconnected from the local application channel controller 34.

If the system 10 is provided with the secure channel 50, the local application channel controller 34 clears out the local channel session key and then emits a disconnection request to the secure element channel controller 37.

After receiving the disconnection request, the secure element channel controller 37 also clears out the secure channel session key and is disconnected from the local application channel controller 34.

In addition, the disconnection request can be emitted while none of any communication happens between the mobile device 30 and the terminal 20 within a predetermined time.

It is to be noted that the step 4 is not essential for attaining the objective of the present invention. In other words, executing the steps 1-3 can also attain the objective of the present invention.

The system of the present invention, according to the trading type, makes the local App enable the smart card to be optionally switched to the non-contactless communication mode or the contactless communication mode and then to emit a corresponding responsive signal for realizing integration of the non-contactless and contactless communications and completing tradings between different communication devices, so the smart card can have comprehensive compatibility. In addition, the secure channel session key can secure the accuracy of data transmission to further boost the convenience and confidentiality of mobile payment.

As mentioned above, the system of the present invention can also be applied to identification. For example, if a user intends to sign in his or her financial account on a banking website, the user can proceed with non-contactless (remote) identification by means of this system, In this way, the secure channel master key can prevent the midway information about his or her identity from theft or tamper and thus secure that only the owner of the account can access it to ensure one and only connection between the account and its owner, When a user intends to do contactless (proximity) identification, e.g. door access at home or company, or admission checking, or even boarding security checking for foreign travel, the user only needs to make a mobile device having the system of the present invention close to a reader and then the mobile device and the reader can quickly exchange and verify identity information therebetween in few seconds, thus enhancing the convenience of the identification. In conclusion, the system of the present invention integrates the non-contactless identification and the contactless identification and encrypts the identity information by utilizing the secure channel master key, thus boosting the convenience of the identification and protecting the information transmitted in the process of the identification.

Although the present invention has been described with respect to specific preferred embodiments thereof, it is in no way limited to the specifics of the illustrated structures but changes and modifications may be made within the scope of the appended claims.

What is claimed is:

1. A system of realizing dual logic channels of secure element, comprising:
a mobile device having a local application module and a secure element module, data transmission being adapted to proceed among the local application module, the secure element module, and a terminal, the mobile device being controllably switched between a contactless communication mode and a non-contactless communication mode by the local application module, the local application module having a local App and a local application channel controller, data transmission being adapted to proceed between the local App and the terminal, the secure element module having a secure element channel controller and a smart element, the smart element having an applet for switchover between the contactless communication mode and the non-contactless communication mode, data transmission being adapted to proceed between the secure element channel controller and the local application channel controller;
at least one channel located between the secure element channel controller and the smart element; and
a communication mode request, which is a contactless communication command or a non-contactless communication command, the communication mode request being emitted from the local App to the applet through the local application channel controller and the secure element channel controller.

2. The system as defined in claim 1, wherein the at least one channel comprises a non-contactless channel and a contactless channel, the non-contactless communication command being transmitted to the smart element through the non-contactless channel when the secure element channel controller transmits the non-contactless communication command, the contactless communication command being transmitted to the smart element through the contactless channel when the secure element channel controller transmits the contactless communication command.

3. The system as defined in claim 1, wherein the at least channel is one in number and when the secure element channel controller transmits the non-contactless communication command or the contactless communication command, the non-contactless communication command or the contactless communication command is transmitted through the channel.

4. The system as defined in claim 1 further comprising a terminal, wherein the terminal is a remote server of non-contactless communication or a reader of contactless communication, non-contactless or contactless communication being adapted to proceed between the mobile device and the terminal, the terminal being the remote server when non-contactless communication proceeds between the mobile device and the terminal, the terminal being the reader when contactless communication proceeds between the mobile device and the terminal.

5. The system as defined in claim 1 further comprising a secure channel, wherein the secure channel is located between the local application channel controller and the secure element channel controller for securing that the local application channel controller and the secure element channel controller are one-on-one and for protecting confidentiality of transmission of contactless communication.

6. The system as defined in claim 2 further comprising a secure channel, wherein the secure channel is located between the local application channel controller and the secure element channel controller for securing that the local application channel controller and the secure element channel controller are one-on-one and for protecting confidentiality of transmission of contactless communication.

7. The system as defined in claim 3 further comprising a secure channel, wherein the secure channel is located between the local application channel controller and the secure element channel controller for securing that the local application channel controller and the secure element channel controller are one-on-one and for protecting confidentiality of transmission of contactless communication.

8. The system as defined in claim 4 further comprising a secure channel, wherein the secure channel is located between the local application channel controller and the secure element channel controller for securing that the local application channel controller and the secure element channel controller are one-on-one and for protecting confidentiality of transmission of contactless communication.

9. The system as defined in claim 5, wherein the secure channel applies a secure channel master key to the local application channel controller and the secure element channel controller for identification and generates a one-time channel session key, the one-time channel session key serving as a security mechanism for preventing information from tamper.

10. The system as defined in claim 1, wherein the secure element module is mounted to one of a microSD card, a SIM card, an embedded secure element, an external device in wired or wireless connection with the mobile device.

11. A method based on the system defined in claim 1, comprising steps of
initializing the local application module and the secure element module such that the local application module and the secure element module becomes default;
transmitting the communication mode request to the local application channel controller from the local App, establishing a channel session between the local application channel controller and the secure element channel controller, transmitting the communication mode request to the secure element channel controller, and setting the smart element as the non-contactless communication mode or the contactless communication mode according to the communication mode request which is the non-contactless communication command or the contactless communication command after the secure element channel controller receives the communication mode request;
transmitting a request signal to the applet of the smart element from the terminal through the local application module, the local application channel controller, and the secure element channel controller, the applet emitting a response signal matching non-contactless or contactless trading or identification to the secure element channel controller, the response signal being transmitted to the terminal through the local application channel controller and the local App after received by the secure element channel controller.

12. The method as defined in claim 11, wherein the secure element channel controller transmits the non-contactless communication command and the contactless communication command through a non-contactless channel and a contactless channel, respectively.

13. The method as defined in claim 11, wherein the secure element channel controller transmits the non-contactless communication command or the contactless communication command through the at least one channel.

14. The method as defined in claim 11, wherein data transmission proceeds between the local application channel controller and the secure element channel controller through a secure channel, and a one-time channel session key is generated based on a secure channel master key and serves as a security mechanism for prevention against tamper.

15. The method as defined in claim 12, wherein data transmission proceeds between the local application channel controller and the secure element channel controller through a secure channel, and a one-time channel session key is generated based on a secure channel master key and serves as a security mechanism for prevention against tamper.

16. The method as defined in claim 13, wherein data transmission proceeds between the local application channel controller and the secure element channel controller through a secure channel and a one-time channel session key is generated based on a secure channel master key and serves as a security mechanism for prevention against tamper.

17. The method as defined in claim 11 further comprises a fourth step of emitting a disconnection request to the secure element channel controller from the local application channel controller, wherein the secure element channel controller is disconnected from the local application channel controller after receiving the disconnection request, thus completing a trading or identification.

18. The method as defined in claim 17, wherein the disconnection request is emitted while none of any communication happens between the mobile device and the terminal within a predetermined time.
